(19) United States
(12) Patent Application Publication
(10) Pub. No.: US 2009/0323662 A1
(43) Pub. Date: Dec. 31, 2009

(54) METHODS AND APPARATUS FOR PACKAGE MANAGEMENT IN A VERTICAL MULTI-FREQUENCY NETWORK

(75) Inventors: AN MEI CHEN, San Diego, CA (US); Binita Gupta, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/342,911

(22) Filed: Dec. 23, 2008

Related U.S. Application Data
(60) Provisional application No. 61/055,393, filed on May 22, 2008.

(51) Int. Cl. H04J 1/00

(52) U.S. Cl. 370/343

(57) ABSTRACT

Methods and apparatus for package management in a vertical multi-frequency network. A method includes linking a plurality of packages into one or more package groups wherein the packages are linked together based on common packages and services so as to minimize RF channel switching, and assigning the package groups to one or more RF channels for transmission in the multi-frequency network. An apparatus is provided for package management in a multi-frequency network. The apparatus includes input logic configured to receive a plurality of packages, and processing logic configure to link the plurality of packages into one or more package groups wherein the packages are linked together based on common packages and services so as to minimize RF channel switching, and assign the package groups to one or more RF channels for transmission in the multi-frequency network.

### CLAIM OF PRIORITY UNDER 35 U.S.C. §119

The present application for patent claims priority to Provisional Application No. 61/055,393 entitled “Methods and apparatus for package management in a vertical multi-frequency network” filed May 20, 2008, and assigned to the assignee hereof and hereby expressly incorporated by reference herein.

### BACKGROUND

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is important for network operators, content retailers, and service providers to have a way to distribute content and/or other network services in a fast and efficient manner and in such a way as to increase bandwidth utilization and power efficiency.

A vertical multi-frequency network (VMFN) is a network in which multiple radio frequency (RF) channels are used in a given local area to transmit independent distribution waveforms with an aim to increase the capacity of the network (in terms of the ability to deliver more content to a device/end user). For instance, a VMFN provides a mode of operation where two waveforms carrying different content are transmitted on two different RF channels in a given local area. The content is in the form of services, which may comprise audio, video, data, or any other type of information. The services are typically provided in a subscription unit referred to as a “package” that may comprise one or more services. Thus, in a given region, a variety of packages are delivered over multiple RF channels.

Typically, a receiving device operating in an MFN may have only one receiver chain due to hardware costs and/or complexity. For example, a receiving device includes receiving logic enabling it to receive only one RF channel at a time. Thus, to receive a desired service, the device may have to switch between RF channels. For example, if a device is tuned to receive a first service on a first RF channel and desires to receive a second service that is carried on a different RF channel, the device will have to perform an RF channel switch to receive the second service. Unfortunately, having to switch to a new RF channel is time consuming and may cause service interruptions resulting in an unsatisfactory user experience. For example, if a device is receiving data associated with a background service and switches to a new RF channel to receive a real time service, the reception of the background service may be interrupted.

Therefore, it would be desirable to have a system that operates to reduce or minimize RF channel switching to improve a user's ability to receive subscribed services in a fast and efficient manner.

### BRIEF DESCRIPTION OF THE DRAWINGS

The foregoing aspects described herein will become more readily apparent by reference to the following Description when taken in conjunction with the accompanying drawings wherein:

FIG. 1 shows a network that comprises aspects of a package management system;

FIGS. 2A-C show exemplary package configurations for use in aspects of a package management system;

FIG. 3 shows exemplary package management logic for use in aspects of a package management system;

FIG. 4 shows an exemplary method for providing aspects of a grouping algorithm for use in aspects of a package management system;

FIG. 5 shows a table that illustrates the operations of a grouping algorithm provided in aspects of a package management system;

FIG. 6 shows an exemplary method for unlinking packages for use in aspects of a package management system; and

FIG. 7 shows exemplary of package management logic for use in aspects of a package management system

### DESCRIPTION

In one or more aspects, a package management system is provided that operates to provide package management to improve a user's ability to receive services in a multi-frequency network. In various aspects, the package management system efficiently organizes packages to be delivered over multiple RF channels in a MFN. The package management system configures the packages so that when they are transmitted over multiple RF channels, the services associated with the packages can be received while RF channel switching is reduced or minimized.

The system is well suited for use in wireless network environments, but may be used in any type of network environment, including but not limited to, communication networks, public networks, such as the Internet, private networks, such as virtual private networks (VPN), local area networks, wide area networks, long haul networks, or any other type of data network.

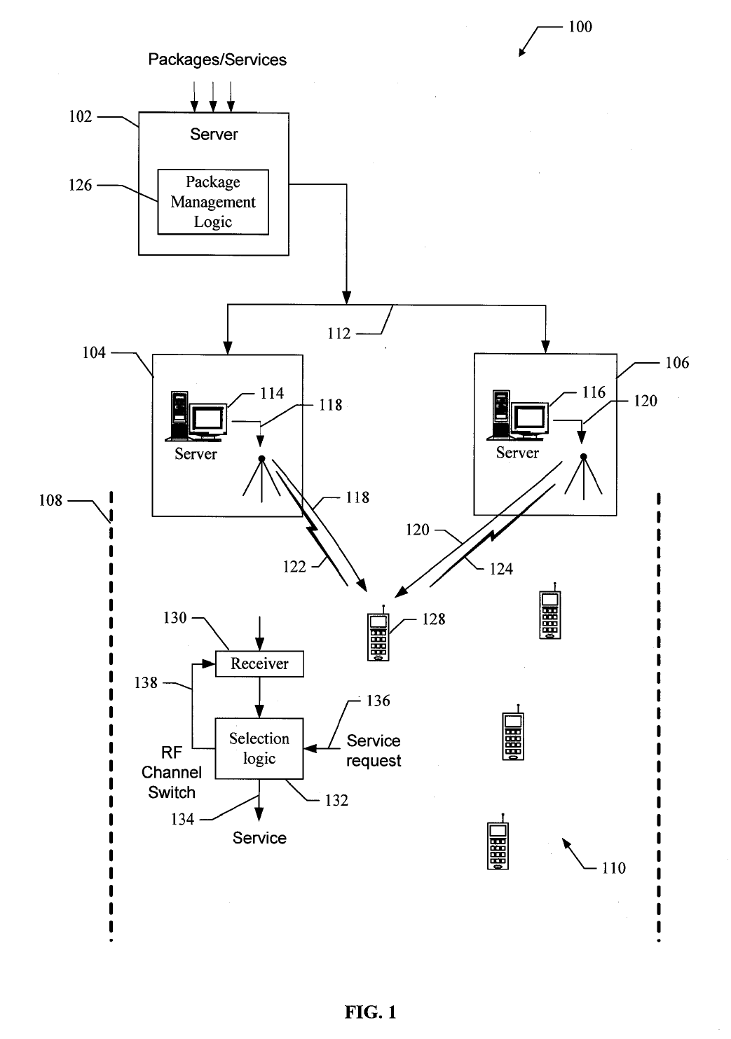

FIG. 1 shows a network 100 that comprises aspects of a package management system. The network 100 comprises a server 102, transmitter sites 104 and 106, a local operations infrastructure (LOI) 108 and devices 110.

The server 102 operates to receive packages and associated services for distribution over selected wide and local areas of a multi-frequency network. To accomplish this, the server 102 is aware of the geographic regions of the network, the RF channels used in each region, and any other network information that may be needed to distribute the packages and associated services.

The server 102 operates to transmit the packages and associated services to the transmitter sites 104 and 106. It should be noted that although only two transmitter sites are shown, the server 102 may transmit the packages and associated services to any number of transmitter sites over any number of local and/or wide geographic regions.

The server 102 transmits the packages and associated services to the transmitter sites 104 and 106 using any suitable transport mechanism, as illustrated at 112. For example, the server 102 transmits the packages and associated services to the transmitter sites using an MPEG-2 transport mechanism. In this configuration, the packages and associated services are assigned MPEG-2 transport identifiers so that each transmitter site can detect and receive appropriate packages and associated services for distribution.

Servers 114 and 116 at the transmitter sites 104 and 106, respectively, use the transport identifiers to determine which packages and associated services are intended for them to transmit over the LOI 108. The servers 114 and 116 then operate to pack their respective packages and associated services into transmission frames 118 and 120, respectively, for transmission over the LOI 108. The servers 114 and 116 utilize any suitable physical layer process to pack the packages and associated services into the transmission frames 118 and 120 for transmission over the LOI 108.

The transmitter site 104 operates to transmit its transmission frames 118 over the LOI 108 using a first RF channel 122, and the transmitter site 106 operates to transmit its transmission frames 120 over the LOI 108 using a second RF channel 124. It should be noted that the two sites 104, 106 may or may not be co-located and that, although time synchronized, different transmission frames are transmitted on each RF channel. Using multiple RF channels allows more services to be transmitted over the LOI 108. The transmission frames 118 and 120 each comprises selected packages and associated services as determined by the operation of the server 102.

The server 102 comprises package management logic 126. The package management logic 126 operates to group the packages and services for efficient transmission over the RF channels available in the region 108. For example, the packages and services are grouped so that when they are transmitted over the region 108, the receiving devices 110 within the region will be able to receive the packages and services to which they have subscribed with a minimal amount of RF channel switching. In an aspect, the package management logic 126 operates to perform a grouping algorithm that determines which packages and/or services are to be transmitted over each RF channel in the region 108. For example, by grouping a package and its associated add-on packages together for transmission over a selected RF channel; a receiving device is able to select any of the associated packages or services without having to perform an RF channel switch. This result in more efficient device operation and a better user experience. A more detailed description of the grouping algorithm performed by the package management logic 126 is provided in other sections of this document.

At the devices 110, a particular device 128 comprises a receiver 130 that operates to tune to a selected RF channel to receive one or more packages and associated services. For example, the receiver 130 operates to tune to the RF channel 122 to receive the transmission frames 118, or tunes to the RF channel 124 to receive the transmission frames 120.

The receiver 130 passes the received transmission frames to selection logic 132 that operates to decode the transmission frames based on a service request 136 to obtain a selected service 134. For example, the service request 136 is provided by the device user or by an application executing on the device 128. The selection logic 132 operates to determine when an RF channel switch 138 is required to obtain a requested service. For example, if a requested service is not available on the current RF channel, the selection logic 132 will output an RF channel switch request 138 to cause the receiver 130 to switch to the RF channel where the requested service is located.

Since the package management logic 126 operates to group the packages and associated service on the RF channels so as to minimize RF channel switches, the device 128 is able to receive packages and associated services with reduced or minimal RF channel switches. This allows a device to perform better and provide a better user experience. It should be noted that the network 100 illustrates just one implementation of a package management system and that other implementations are possible within the scope of the various aspects.

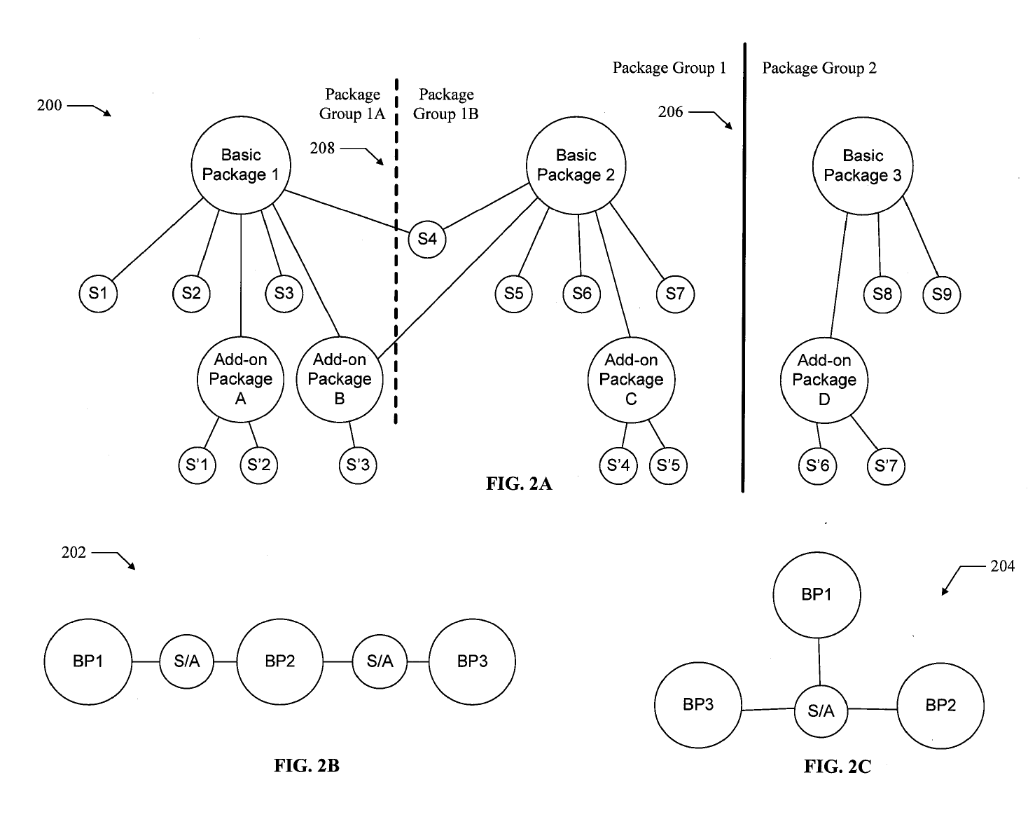

FIGS. 2A-C show exemplary package configurations for use in aspects of a package management system. For example, the package configuration 200 represents a configuration of packages and services that are input to the server 102 shown in FIG. 1. The package configuration 200 comprises three basic packages that each has one or more associated services (Sₙ). Each of the basic packages also has one or more add-on packages (A-D), which may represent premium services, such as sports, movies, or other premium services. Associated with each add-on package are add-on services (S′_{N}).

The package configuration 200 illustrates how the basic packages can have common services and/or common add-on packages. For example, the service (S4) and the add-on package B are common between basic package 1 and basic package 2.

FIG. 2B illustrates the package configuration 202 wherein package chains are formed when multiple basic packages share one or more services and/or add-on packages (S/A) in a serial fashion.

FIG. 2C illustrates the package configuration 204 wherein package stars are formed when multiple basic packages share a common service and/or add-on package.

In various aspects, the package management system operates to group the basic packages, services and add-on packages into groups for distribution over RF channels of a multi-frequency network. The groupings are determined so that a receiving device can receive the services while minimizing RF channels switches.

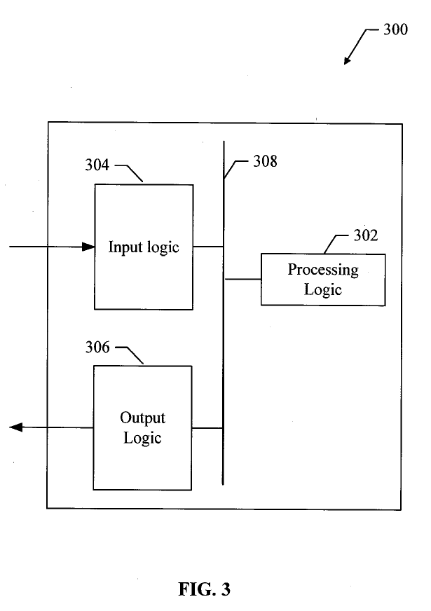

FIG. 3 shows exemplary package management logic 300 for use in aspect of a package management system. For example, the package management logic 300 is suitable for use as the package management logic 126 shown in FIG. 1. The package management logic 300 comprises processing logic 302, input logic 304, and output logic 306 all coupled to a data bus 308.

The input logic 304 comprises at least one of a CPU, processor, gate array, hardware logic, memory elements, and/or hardware executing software. The input logic 304 operates to receive packages, associated services, and add-on packages that are to be distributed over wide and local regions of a multi-frequency distribution network.

The processing logic 302 comprises at least one of a CPU, processor, gate array, hardware logic, memory elements, and/or hardware executing software. The processing logic 302 operates to group the packages, services, and add-on packages into package groups that are assigned to the RF channels available in a multi-frequency network. The processing logic 302 performs a grouping algorithm to generate the package groups. When the package groups are delivered over the MFN on their assigned RF channel, devices receiving the services associated with the packages can do so with minimal RF channel switches. A more detailed description of the grouping algorithm is provided in another section of this document.

In an aspect, the processing logic 302 also operates to unlink package groups so that the packages can be accommodated by the available bandwidth. For example, the processing logic 302 operates to generate a package group for transmission over a selected RF channel. However, if it is determined that there is not enough bandwidth available on that RF channel, the processing logic 302 operates to unlink the package group based on unlinking criteria so as to form two or more package groups that are then assigned to RF channels for transmission. A more detailed description of how the processing logic 302 unlinks package groups is provided in other sections of this document.

The output logic 306 comprises at least one of a CPU, processor, gate array, hardware logic, memory elements, and/or hardware executing software. The output logic 306 operates to output the package groups for distribution to LOIs in a multi-frequency network.

In an aspect, the package management system comprises a computer program product comprising one or more program instructions (“instructions”) or sets of “codes” stored or embodied on a machine-readable medium, which when executed by at least one processor, for instance, a processor at the package management logic 300, provides the functions described herein. For example, the sets of codes may be loaded into the package management logic 300 from a machine-readable medium, such as a floppy disk, CDROM, memory card, FLASH memory device, RAM, ROM, or any other type of machine-readable medium that interfaces to the package management logic 300. In another aspect, the sets of codes may be downloaded into the package management logic 300 from an external device or network resource. The sets of codes, when executed, provide aspects of a package management system as described herein.

In various aspects of a package management system, a grouping algorithm is performed to group packages and services for distribution over a multi-frequency network. The following definitions describe four package categories processed by the grouping algorithm.
Category 1—Package with no shared services and no shared add-on packages.
Category 2—Package with shared services and no shared add-on packages.
Category 3—Package with no shared services and shared add-on packages.
Category 4—Package with shared services and shared add-on packages.

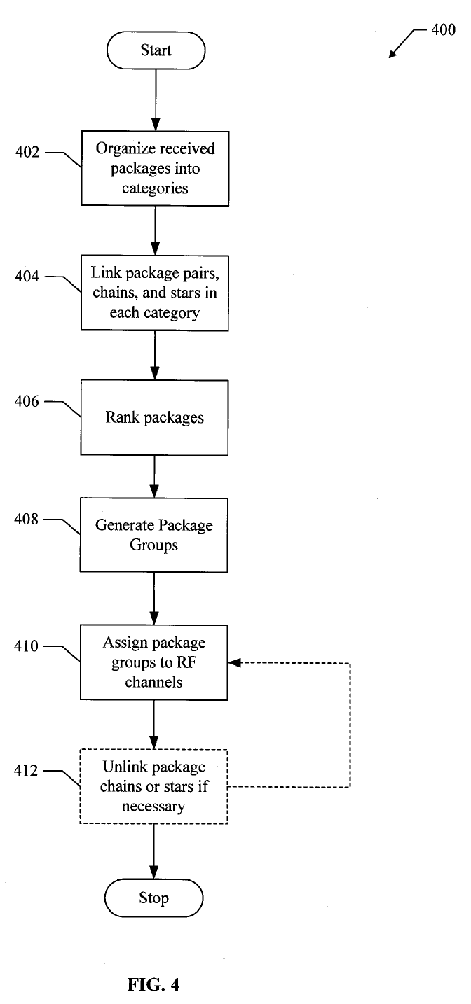

FIG. 4 shows an exemplary method 400 for providing aspects of a grouping algorithm for use in aspects of a package management system. For example, in an aspect, the processing logic 302 executes one or more sets of codes to control the package management logic 300 to perform the functions described below. In another aspect, the package management logic 300 comprises at least one integrated circuit that comprises one or more modules configured to perform the functions described below. For clarity, a description is provided to illustrate the operation of the processing logic 302 to group the packages and services of the package configuration 200 for distribution over a multi-frequency network.

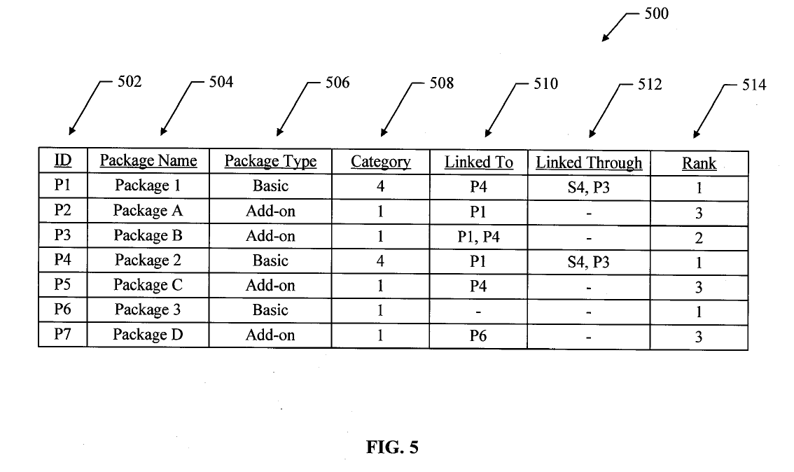

FIG. 5 shows a table 500 that illustrates the operations of the grouping algorithm. For example, the table 500 comprises a package identifier 502, package name 504, package type 506, package category 508, a “linked to” field 510, a “linked through” field 512, and a package rank 514. For clarity the method 400 is described below with reference to the package management logic 300 and the table 500.

At block 402, received packages and associated services are organized into the four package categories described above. For example, the processing logic 302 operates to organize the received packages and associated services into the table 500 so that the package identifier 502, package name 504, package type 506, and package category 508 are completed based on the package configuration 200.

At block 404, package chains and stars are identified and entries in the “linked to” 510 and “linked through” 512 columns are made. For example, the processing logic 302 operates to identify packages that share services and/or add-on packages to complete the “linked to” 510 and “linked through” 512 columns of the table 500. For example, package 1 shares service S4 with package 2, so an entry of P4 is placed in the “linked to” column 510 associated with package 1 and S4 is placed in the “linked through” column 512. Furthermore, package 1 shares add-on package B with package 2, so an entry of P3 is also placed in the “linked through” column 512. The processing logic 302 operates to determine all the package chains and stars and complete the table 500 accordingly.

At block 406, the packages are ranked. For example, in an aspect, the packages are ranked by their respective category. In another aspect, the packages are ranked by any other criteria, such as by size, priority, or any other criteria. In the table 500, the basic packages are ranked with “1”, shared add-on packages are ranked with “2”, and unshared add-on packages are ranked with “3.”

At block 408, the packages are grouped into package groups so that all linked packages are placed in a single group. In an aspect, the processing logic 302 operates to generate the package groups from the table 500 by grouping all the packages that are linked together according to the “linked to” column. The following two package groups are generated, which is also illustrated by the line 206 in FIG. 2.

### 1. Package Group 1 (P1, P2, P3, P4, P5, P6)

### 2. Package Group 2 (P6, P7)

At block 410, the package groups are assigned to RF channels to be distributed in a MFN. For example, in an aspect, the package group 1 is assigned to a first RF channel in a particular LOI, and the package group 2 is assigned to a second RF channel in that LOI. By assigning the entire package group to a particular RF channel, a receiving device is able to receive all of the services associated with the package group without having to switch RF channels. It should be noted that other RF channel assignments are possible.

At block 412, an optional operation is performed if an RF channel does not have enough bandwidth to carry a particular package group. In an aspect, package chains or stars in a package group are unlinked if necessary to accommodate bandwidth limitations. For example, a long package chain or star may not be able to fit in the available bandwidth of an RF channel. In this case, the package chain or star may be unlinked to form smaller package groups so that the smaller groups can be assigned to the available bandwidth. In an aspect, the long package chain or star is unlinked and/or regrouped using any criteria, such as ranking and/or package category. A more detailed description of unlinking and regrouping is provided in another section of this document. If block 412 is performed, the method proceeds to block 410 where the smaller package groups can be assigned to RF channels.

Thus, the method 400 operates to group packages, services, and add-on packages in aspects of a package management system. It should be noted that the method 400 represents just one implementation and that other implementations are possible within the scope of the aspects

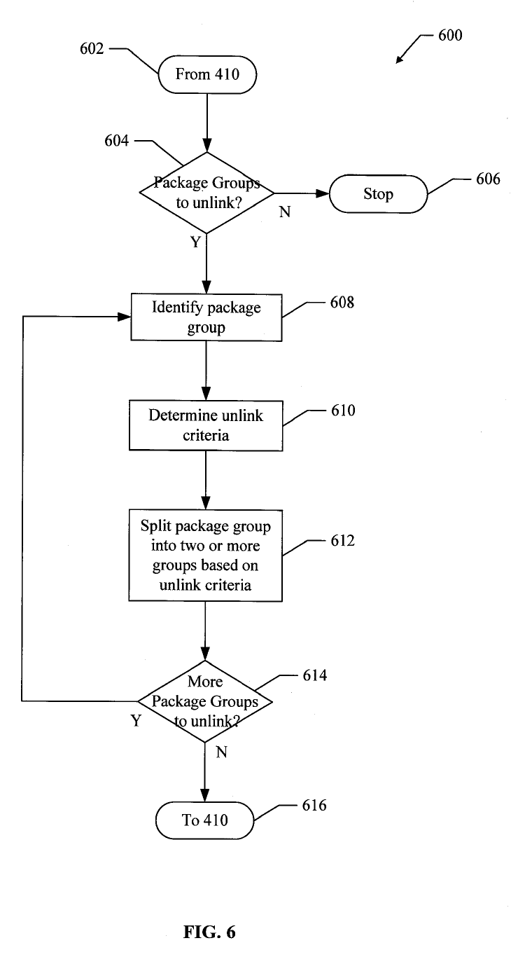

FIG. 6 shows an exemplary method 600 for unlinking package groups for use in aspects of a package management system. For example, the method 600 is suitable for use as block 412 in the method 400. For clarity, the method 600 is described herein with reference to the package management logic 300 shown in FIG. 3 and the package configuration 200 shown in FIG. 2. For example, in an aspect, the processing logic 302 executes one or more sets of codes to control the package management logic 300 to perform the functions described below. In another aspect, the package management logic 300 comprises at least one integrated circuit that comprises one or more modules configured to perform the functions described below.

At block 602, the method 600 is entered from block 410 in the method 400 shown in FIG. 4.

At block 604, a determination is made as to whether there are any package groups that need to be unlinked in order to reduce their size. For example, if a package group is too large to fit within the available bandwidth on a selected RF channel, that package group may be selected to be unlinked. In an aspect, the processing logic 302 operates to make the determination. If there are not package groups that need to be unlinked, the method stops at block 606. If there are package groups that need to be unlinked, the method proceeds to block 608. For the purpose of this description, it will be assumed that the package group 1 identified above needs to be unlinked to fit within the available bandwidth of an RF channel.

At block 608, a package group to be unlinked is identified. In an aspect, the processing logic 302 operates to identify the package group 1 as a package group that needs to be unlinked.

At block 610, unlink criteria are determined. In an aspect, package groups are unlinked based on one or more criteria that comprise but are not limited to; bandwidth requirements, package category, service or package size, service or package priority, total services, number of shared services between packages, and/or any other criteria. In an aspect, the processing logic 302 makes this determination. For the purpose of this description, it will be assumed that the unlink criteria is bandwidth availability.

At block 612, the identified package group is unlinked into two or more package groups based on the selected unlink criteria. For example, because of a bandwidth limitation associated with RF channel 1, the processing logic 302 operates to unlink the package group 1 to form two groups so that each unlinked group does not exceed a selected maximum bandwidth limit. As a result, the processing logic 302 operates to unlink package group 1 to form two package groups (1A and 1B) as illustrated by the line 208 in FIG. 2. Package group 1A comprises basic package 1 and add-on packages A and B. Package group 1B comprises basic package 2, service S4 and add-on package C. Furthermore, the table 500 is updated to reflect that package group 1 has been split into two groups. For example, in the table 500, P1 is no longer linked to P4.

At block 614, a determination is made as to whether there are more package groups that need to be unlinked. If there are more groups to unlink, the method proceeds to block 608. If there are no more groups to unlink, the method returns to block 410 of the method 400. In an aspect, the processing logic 302 makes this determination.

Thus, the method 600 operates to unlinked grouped packages in aspects of a package management system. It should be noted that the method 600 represents just one implementation and that other implementations are possible within the scope of the aspects.

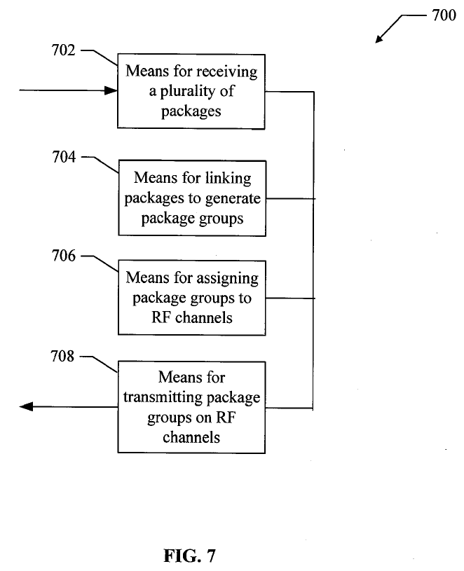

FIG. 7 shows exemplary package management logic 700 for use in aspects of a package management system. For example, the package management logic 700 is suitable for use as the package management logic 126 shown in FIG. 1. In an aspect, the package management logic 700 is implemented by at least one integrated circuit one or more modules comprising hardware and/or hardware executing software and configured to provide aspects of a package management system as described herein.

The package management logic 700 comprises a first module comprising means (702) for receiving a plurality of packages. In an aspect, the means 702 comprises the input logic 304. The package management logic 700 also comprises a second module comprising means (704) for linking packages to generate package groups. In an aspect, the means 704 comprises the processing logic 302. The package management logic 700 also comprises a third module comprising means (706) for assigning package groups to RF channels. In an aspect, the means 706 comprises the processing logic 302. The package management logic 700 also comprises a fourth module comprising means (708) for transmitting package groups on RF channels. In an aspect, the means 708 comprises the output logic 306.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of a package management system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for package management in a multi-frequency network, the method comprising:
linking a plurality of packages into one or more package groups; and
assigning the package groups to one or more RF channels for transmission in the multi-frequency network.

2. The method of claim 1, further comprising transmitting the package groups on the one or more RF channels in the multi-frequency network.

3. The method of claim 1, wherein said linking comprises linking the plurality of packages together based on common packages and services so as to minimize RF channel switching.

4. The method of claim 1, wherein said assigning comprises:
determining whether a selected package group will fit in available bandwidth associated with a selected RF channel; and
if the selected package group will not fit:
unlinking the selected package group into two or more smaller package groups based on at least one unlinking criteria; and
assigning at least one of the two or more smaller package groups to the available bandwidth associated with the selected RF channel.

5. The method of claim 4, wherein said unlinking comprises selecting the at least one unlinking criteria from a set of criteria comprising bandwidth requirements, package category, service size, package size, service priority, package priority, total services, total shared services, and rank.

6. The method of claim 1, further comprising receiving the plurality of packages, wherein the plurality of packages comprise basic packages and add-on packages.

7. An apparatus for package management in a multi-frequency network, the apparatus comprising:
input logic configured to receive a plurality of packages; and
processing logic configure to link the plurality of packages into one or more package groups, and assign the package groups to one or more RF channels for transmission in the multi-frequency network.

8. The apparatus of claim 7, further comprising output logic configured to transmit the package groups on the one or more RF channels in the multi-frequency network.

9. The apparatus of claim 7, wherein said processing logic is configured to link the plurality of packages together based on common packages and services so as to minimize RF channel switching.

10. The apparatus of claim 7, wherein said processing logic is configured to:
determine whether a selected package group will fit in available bandwidth associated with a selected RF channel; and
if the selected package group will not fit:
unlink the selected package group into two or more smaller package groups based on at least one unlinking criteria; and
assign at least one of the two or more smaller package groups to the available bandwidth associated with the selected RF channel.

11. The apparatus of claim 10, wherein said processing logic is configured to select the at least one unlinking criteria from a set of criteria comprising bandwidth requirements, package category, service size, package size, service priority, package priority, total services, total shared services, and rank.

12. The apparatus of claim 7, wherein said input logic is configured to receive the plurality of packages, wherein the plurality of packages comprise basic packages and add-on packages.

13. An apparatus for package management in a multi-frequency network, the apparatus comprising:
means for linking a plurality of packages into one or more package groups; and
means for assigning the package groups to one or more RF channels for transmission in the multi-frequency network.

14. The apparatus of claim 13, further comprising means for transmitting the package groups on the one or more RF channels in the multi-frequency network.

15. The apparatus of claim 13, wherein said means for linking comprises means for linking the plurality of packages together based on common packages and services so as to minimize RF channel switching.

16. The apparatus of claim 13, wherein said means for assigning comprises:
means for determining whether a selected package group will fit in available bandwidth associated with a selected RF channel; and
if the selected package group will not fit:
means for unlinking the selected package group into two or more smaller package groups based on at least one unlinking criteria; and
means for assigning at least one of the two or more smaller package groups to the available bandwidth associated with the selected RF channel.

17. The apparatus of claim 16, wherein said means for unlinking comprises means for selecting the at least one unlinking criteria from a set of criteria comprising bandwidth requirements, package category, service size, package size, service priority, package priority, total services, total shared services, and rank.

18. The apparatus of claim 13, further comprising means for receiving the plurality of packages, wherein the plurality of packages comprise basic packages and add-on packages.

19. A computer program product for package management in a multi-frequency network, the computer program product comprising:
a computer-readable medium encoded with codes executable to:
link a plurality of packages into one or more package groups; and
assign the package groups to one or more RF channels for transmission in the multi-frequency network.

20. The computer-readable medium of claim 19, further encoded with codes executable to transmit the package groups on the one or more RF channels in the multi-frequency network.

21. The computer-readable medium of claim 19, wherein said codes executable to link comprise codes executable to link the plurality of packages together based on common packages and services so as to minimize RF channel switching.

22. The computer-readable medium of claim 19, wherein said codes executable to assign comprise:
codes executable to determine whether a selected package group will fit in available bandwidth associated with a selected RF channel; and
if the selected package group will not fit:
codes executable to unlink the selected package group into two or more smaller package groups based on at least one unlinking criteria; and
codes executable to assign at least one of the two or more smaller package groups to the available bandwidth associated with the selected RF channel.

23. The computer-readable medium of claim 22, wherein said codes executable to unlink comprises codes executable to select the at least one unlinking criteria from a set of criteria comprising bandwidth requirements, package category, service size, package size, service priority, package priority, total services, total shared services, and rank.

24. The computer-readable medium of claim 19, further comprising codes executable to receive the plurality of packages, wherein the plurality of packages comprise basic packages and add-on packages.

25. At least one processor configured to provide for package management in a multi-frequency network, the at least one processor comprising:
a first module for linking a plurality of packages into one or more package groups; and
a second module for assigning the package groups to one or more RF channels for transmission in the multi-frequency network.

26. The at least one processor of claim 25, further comprising a third module for transmitting the package groups on the one or more RF channels in the multi-frequency network.

27. The at least one processor of claim 25, wherein said first module is configured to link the plurality of packages together based on common packages and services so as to minimize RF channel switching.

28. The at least one processor of claim 25, wherein said first module is configured to:
determine whether a selected package group will fit in available bandwidth associated with a selected RF channel; and
if the selected package group will not fit:
unlink the selected package group into two or more smaller package groups based on at least one unlinking criteria; and
assign at least one of the two or more smaller package groups to the available bandwidth associated with the selected RF channel.

29. The at least one processor of claim 28, wherein said first module is configured to select the at least one unlinking criteria from a set of criteria comprising bandwidth requirements, package category, service size, package size, service priority, package priority, total services, total shared services, and rank.

30. The at least one processor of claim 25, further comprising a third module configured to receive the plurality of packages, wherein the plurality of packages comprise basic packages and add-on packages.
